(19) United States
(12) Patent Application Publication
(10) Pub. No.: US 2016/0014207 A1
(43) Pub. Date: Jan. 14, 2016

(54) Chipset For Cellular M2M Communications

(71) Applicant: Kurt Busch, Irvine, CA (US)

(72) Inventor: Kurt Busch, Irvine, CA (US)

(73) Assignee: Lantronix, Inc., Irvine, CA (US)

(21) Appl. No.: 14/794,718

(22) Filed: Jul. 8, 2015

Related U.S. Application Data
(60) Provisional application No. 62/022,533, filed on Jul. 9, 2014.

(51) Int. Cl. H04L 29/08; H04W 76/02; H04W 4/00

(52) U.S. Cl. CPC H04L 67/125; H04W 4/005; H04W 76/023

(57) ABSTRACT

An apparatus and a method are provided for a cellular machine-to-machine (M2M) chipset configured to be coupled to a legacy device whereby the legacy device may be remotely monitored, operated, or controlled. The chipset has just enough processing power to establish a cellular network connection. A client cellular interface and a cellular access point are supported by the cellular network connection. The client cellular interface is configured to establish cellular connections with a communications network, whereby data passed to the client cellular interface is routed within the communications network to a computing device. The cellular access point is configured to receive cellular connections whereby the computing device may connect directly to the cellular M2M chipset.

### CROSS REFERENCE TO RELATED APPLICATIONS

This application claims the benefit of U.S. Provisional Application No. 62/022,533 filed on Jul. 9, 2014, the entirety of said application is incorporated herein by reference.

### FIELD OF THE INVENTION

The field of the present invention generally relates to cellular communications. More particularly, the field of the invention relates to an apparatus and a method for a low throughput cellular end-node chipset which connects to cellular networks for the purpose of performing machine-to-machine (M2M) communications.

### BACKGROUND

Generally, when machines communicate with one another, they do so in a language known as “telemetry.” Telemetry is an automated communications process whereby measurements may be performed and other data collected at remote or inaccessible locations and then transmitted to receiving equipment for monitoring. Today, wireless sensors, the Internet, and personal computers are being combined in various ways to create Machine-to-Machine (M2M) communications.

M2M communications typically comprise a remote sensor which gathers data and sends it wirelessly to a network, wherein the data is next routed, often through the Internet, to a server such as a personal computer. The data may then be analyzed and acted upon by way of software on the personal computer. In many ways, telemetry technology may be considered a forerunner of more advanced M2M communications systems is use today. Telemetry communications and M2M communications both transmit data received from a sensor. Unlike telemetry communications, however, M2M communications utilize existing networks, such as wireless networks used by the public, to transmit data. The explosive growth of public wireless networks has made M2M communications much more readily available.

One area of difficulty encountered in setting up multiple M2M devices is provisioning wireless devices. In the area of network computing, the term “provisioning” generally refers to the process of configuring a network-compatible device, selecting an appropriate network, and establishing a connection to the network. A user interface (UI), or a human machine interface (HMI), stored on a computer, a phone, a laptop, or any other similar computing device, generally shows a user a list of available networks and enables the user to select a desired network to which to connect. The HMI further enables the user to enter a suitable username and password required for connecting the network, and then configure the network connection, if need be.

Although in this day and age connecting to networks is far simpler than ever before, connecting to a network becomes more complicated when the device to be connected lacks any kind of HMI or user interface. Such a device is typically referred to as a “headless device.” Moreover, in the case of Wi-Fi, every device has a different password and settings, which makes provisioning headless Wi-Fi devices very difficult, if not nearly impossible. Those skilled in the art will appreciate that connecting a headless cellular device may often be accomplished with relative ease simply because a Subscriber Identification Module (i.e., a SIM card) associated with the cellular device is already provisioned with the network connection. The simplicity of connecting headless cellular devices to a wireless network makes such devices an excellent candidate for M2M communications.

A drawback to using conventional cellular chipsets for M2M communications is that conventional cellular chipsets are very expensive due to the level of throughput required to perform all the functions typical of modern cellular phones. What has been needed, and not previously available, is a method and an apparatus for a low throughput cellular end-node chipset which connects to cellular networks for the purpose of performing M2M communications. The present invention satisfies these, and other needs.

### SUMMARY OF THE INVENTION

In its most general aspect, the present invention includes a cellular M2M chipset having a processor, a communications controller, memory of storage of data and software programs for configuring the controller to operate in a specific manner to perform specific tasks, and a communication module which may include an antenna, communication bus, and other electronic circuits necessary for connecting to and communicating with a cellular network. Electronic circuits and appropriate software programs may also be included to facilitate monitoring and control of devices or sensors connected to or in communication with the M2M chipset.

In one aspect, the present invention includes an apparatus for a cellular machine-to-machine (M2M) chipset configured to be coupled to a legacy device whereby the legacy device may be remotely monitored, operated, or controlled, the apparatus comprising a chipset that has just enough processing power to establish a cellular network connection; a Subscriber Identification Module (SIM) associated with the cellular M2M chipset which is provisioned with the cellular network connection; and a client cellular interface and a cellular access point supported by the cellular network connection, the client cellular interface being configured to establish cellular connections with a communications network, whereby data passed to the client cellular interface is routed within the communications network to a computing device, and the cellular access point is configured to receive cellular connections whereby the computing device may connect directly to the cellular M2M chipset.

In another aspect, the cellular M2M chipset comprises a very low throughput compared to conventional cellular chipsets utilized in cellular handsets. In an alternative aspect, the cellular M2M chipset is an LTE end-node chipset which attaches to an LTE network. In another alternative aspect, the cellular M2M chipset comprises limited functionality so as to support M2M connectivity. In still another alternative aspect, the cellular M2M chipset lacks a user interface or a Human Machine Interface (HMI).

In yet another aspect, the legacy device is incapable of communicating or establishing network connections in absence of the cellular M2M chipset. In still another aspect, the computing device is configured to receive M2M communications from the cellular M2M chipset.

In a further aspect, the invention includes a software application stored on a non-transitory machine-readable medium of the computing device, wherein the software application is configured to establish a cellular connection between the computing device and the cellular M2M chipset by way of the cellular access point, and wherein the software application effectively operates as a user interface for the cellular M2M chipset, thereby enabling a user to remotely monitor, operate, and control the legacy device by way of the computing device.

In another aspect, the computing device is a mobile phone or a tablet computer. In an alternative aspect, the computing device is a portable computing device capable of participating in a wireless cellular connection.

In still another aspect, the cellular M2M chipset periodically sends information about the status of the legacy device to the computing device. In another alternative aspect, the computing device includes a software application which receives the information sent by the cellular M2M chipset and then displays the information to the user. In another alternative aspect, the information is deployed as a Webpage, which periodically updates and displays new information received from the cellular M2M chipset.

In still another aspect, the invention includes a method for connecting a computing device to a legacy device so as to remotely monitor, operate, or control the legacy device, the method comprising: providing a cellular machine-to-machine (M2M) chipset that has just enough processing power to establish a cellular network connection comprising a Subscriber Identification Module (SIM) which is provisioned with a cellular network connection; configuring the cellular network connection to support a client cellular interface and a cellular access point, wherein the client cellular interface is configured to establish cellular connections with a communications network, whereby data passed to the client cellular interface is routed within the communications network to the computing device, and wherein the cellular access point is configured to receive cellular connections whereby the computing device may connect directly to the cellular M2M chipset; and coupling the cellular M2M chipset to the legacy device, such that the legacy device is responsive to commands received from the computer device to the cellular M2M chipset by way of the cellular network connection.

In a further aspect, the invention may also include providing a software application stored on a non-transitory machine-readable medium of the computing device, wherein the software application is configured to establish a cellular connection between the computing device and the cellular M2M chipset by way of the cellular network connection, and wherein the software application effectively operates as a user interface for the cellular M2M chipset, thereby enabling a user to remotely monitor, operate, or control the legacy device by way of the computing device.

In another aspect, coupling the cellular M2M chipset to the legacy device further comprises configuring the cellular M2M chipset to periodically send information about the status of the legacy device to the computing device. In yet another aspect, the computing device includes a software application which receives the information sent by the cellular M2M chipset and then displays the information to the user, and wherein the software application sends user-entered commands to the cellular M2M chipset, such that the software application operates as a Human Machine Interface (HMI) for the cellular M2M chipset.

In still another aspect, the invention includes a system a cellular M2M chipset for providing communication with and control a device having no network connectivity, comprising: a processor; a memory in operable communication with the processor; a communication module in operative communications with the processor and the memory, the communication module providing for connection to a cellular network and a device or sensor having no ability to connect with a network; and a software program stored in the memory, the software program consisting of programming commands for controlling the processor to establish a cellular connection through the communication module with a cellular network.

In one alternative aspect, the software program includes programming commands for controlling the processor to communicate with the device or sensor. In another alternative aspect, the processor and communication module comprise a very low throughput compared to conventional cellular chipsets utilized in cellular handsets. In still another alternative aspect, the communication module is configured as an LTE end-node.

In another aspect, the software program lacks programming commands for providing a user interface. In still another aspect, the memory is a subscriber identification module.

Other features and advantages of the present invention will become apparent from the following detailed description, taken in conjunction with the accompanying drawings, which illustrate, by way of example, the principles of the invention.

### BRIEF DESCRIPTION OF THE DRAWINGS

FIG. 1 is a block diagram illustrating an embodiment of an exemplary use environment wherein a cellular M2M chipset is remotely operated by way of a mobile device in accordance with the present invention;

FIG. 2 is a block diagram illustrating an embodiment of an exemplary use environment wherein a cellular M2M chipset is remotely operated by way of a mobile device in accordance with the present invention; and

FIG. 3 is a block diagram illustrating an embodiment of an exemplary use environment wherein a cellular M2M chipset is remotely monitored by way of a monitoring computer in accordance with the present invention.

### DETAILED DESCRIPTION OF THE SEVERAL EMBODIMENTS

In the following description, numerous specific details are set forth in order to provide a thorough understanding of the present invention. It will be apparent, however, to one of ordinary skill in the art that the present invention may be practiced without these specific details. In other instances, well known components or methods have not been described in detail but rather in a block diagram, or a schematic, in order to avoid unnecessarily obscuring the present invention. Further specific numeric references such as “first driver,” may be made. However, the specific numeric reference should not be interpreted as a literal sequential order but rather interpreted that the “first driver” is different than a “second driver.” Thus, the specific details set forth are merely exemplary. The specific details may be varied from and still be contemplated to be within the spirit and scope of the present invention. The term “coupled” is defined as meaning connected either directly to the component or indirectly to the component through another component.

Throughout the description reference will be made to various software programs and hardware components that provide and carryout the features and functions of the various embodiments of the present invention. Software programs may be embedded onto a machine-readable medium. A machine-readable medium includes any mechanism that provides, stores or transmits information in a form readable by a machine, such as, for example, a computer, server or other such device. For example, a machine-readable medium includes read only memory (ROM); random access memory (RAM); magnetic disk storage media; optical storage media; flash memory devices; digital video disc (DVD); EPROMs; EEPROMs; flash memory; magnetic or optical cards; or any type of media suitable for storing electronic instructions.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms may be written in a number of different software programming languages. Also, an algorithm may be implemented with lines of code in software, configured logic gates in software, or a combination of both.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

In an embodiment, the logic consists of electronic circuits that follow the rules of Boolean Logic, software that contain patterns of instructions, or any combination of both.

The term “server” is used throughout the following description. Those skilled in the art understand that a server is a computer program that provides services to other computer programs running on the same computer or processor as the server application is running, and/or other computers or processors different from the computer or processor on which the server is running. Often, the computer or processor on which the server program is running is referred to as the server, although other programs and applications may also be running on the same computer or processor. It will be understood that a server forms part of the server/client model. As such, the processor running the server program may also be a client, requesting services from other programs, and also operate as a server to provide services to other programs upon request. It is understood that the computer or processor upon which a server program is running may access other resources, such as memory, storage media, input/output devices, communication modules and the like.

Similarly, a cloud server is a server that provides shared services to various clients that access the cloud server through a network, such as a local area network and the Internet. In a cloud based system, the server is remote from the clients, and various clients share the resources of the cloud server. Information is passed to the server by the client, and returned back to the client through the network, usually the Internet.

In general, an apparatus and a method are provided for a cellular machine-to-machine (M2M) chipset configured to be coupled to a legacy device whereby the legacy device may be remotely monitored, operated, or controlled. As used herein, the term “legacy device” is intended to describe any computer system, machine, or device that is not network-compatible on its own. In an embodiment, the cellular M2M chipset is an LTE end-node chipset which attaches to an LTE network. The apparatus comprises a chipset that has just enough processing power to establish a cellular network connection. The network connection is provisioned with a Subscriber Identification Module (SIM) associated with the cellular M2M chipset.

A client cellular interface and a cellular access point are supported by the cellular network connection. The client cellular interface is configured to establish cellular connections with a communications network, whereby data passed to the client cellular interface is routed within the communications network to a computing device. The cellular access point is configured to receive cellular connections whereby the computing device may connect directly to the cellular M2M chipset. The computing device preferably includes a software application which receives the information sent by the cellular M2M chipset and then displays the information to the user.

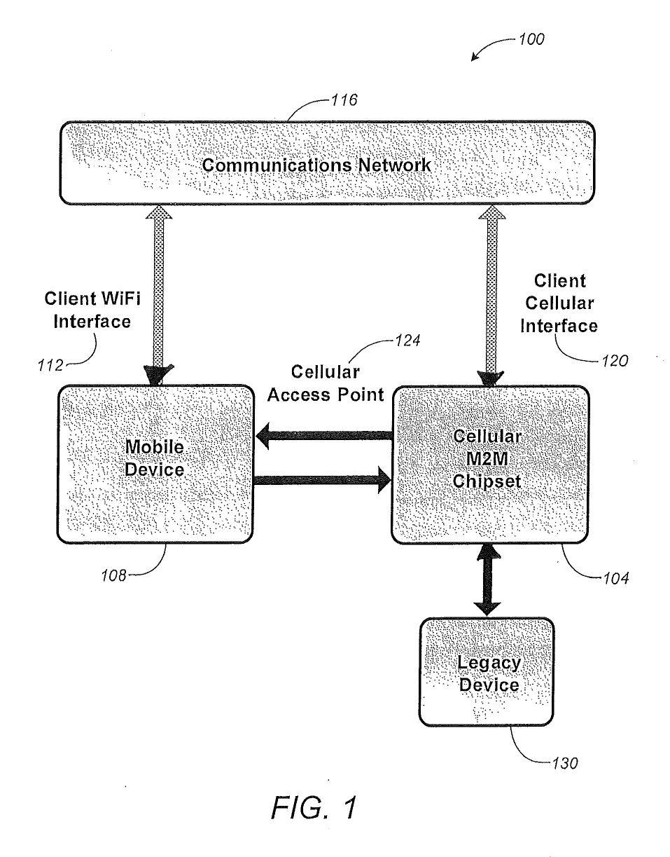

FIG. 1 is a block diagram illustrating an embodiment of an exemplary use environment 100 wherein a cellular M2M chipset 104 is remotely operated by way of a mobile device 108 in accordance with the present invention. The M2M chipset typically includes a processor, a memory in operable communication with the processor, a communications module that enables communication between the processor of the M2M chipset and networks and/or devices external to the M2M chipset. In one embodiment, the M2M chipset also includes and cellular transmitter/receiver that provides for connection to a cellular network by the M2M chipset. In some embodiments, software commands which comprise various software programs may be stored or embedded in the memory which may be accessed by the processor or be used to configure the processor to carry out various functions, such as, for example, establishing a cellular communication connection over a cellular network or for monitoring and/or controlling a legacy device, such as legacy device 130.

Mobile device 108 preferably is a mobile phone or a tablet computer with cellular capabilities. In other embodiments, however, the mobile device may be any computing device capable of participating in a cellular connection.

The mobile device 108 further comprises a client Wi-Fi interface 112 which is suitably configured to establish wireless connections with various access points within a communications network 116. The cellular M2M chipset 104 may be a cellular-enabled device that lacks a user interface (UI) or a Human Machine Interface (HMI). As depicted, cellular M2M chipset 104 may be connected to legacy device 130, or any device which is otherwise incapable of communicating with the mobile device 108 or of establishing a network connection on its own.

The cellular M2M chipset 104 comprises a Subscriber Identification Module (that is, a SIM card) associated with the cellular M2M chipset and is already provisioned with a network connection which supports both a client cellular interface 120 and a cellular access point 124. The SIM card is a smart card having a memory storage medium that stores data for cellular device subscribers. Such data may include, for example, user identity, location and phone number, network authorization data, personal security keys, contact lists, stored text messages or other data.

The client cellular interface 120 is configured to establish cellular connections with the communications network 116. It is envisioned that data passed to the client cellular interface 120 may be routed by way of routers within the communications network 116 to the Internet, whereby the mobile device 108 may access the data by way of the client Wi-Fi interface 112. The cellular access point 124 is configured to receive cellular connections whereby the mobile device 108 may directly connect to the cellular M2M chipset 104 without data having to be routed to the client Wi-Fi interface 112.

In some embodiments, the cellular M2M chipset 104 may be configured to publish the cellular access point 124 as an available access point whereby the mobile device 108 may connect to the cellular M2M chipset 104. It will be understood by those skilled in the art that the act of “publishing” includes transmitting a signal that can be received and recognized by a receiver, such as is included in mobile device 108.

In some embodiments, the mobile device 108 may include a software application, stored on a non-transitory machine-readable medium of the mobile device 108, which configures a processor of the mobile device to automatically detect and scan the characteristics of all available access points within the communications network 116, including the published cellular access point 124.

The software application being run by the processor of the mobile device may be configured to distinguish between access points that are suitable for Wi-Fi Internet access and those that are cellular, such as the cellular access point 124. In one embodiment, a user of the mobile device 108 may select various access points from a list, such as a drop down list or other list displayed on a display of the mobile device, and then provide an appropriate password for the selected network. When the user selects the cellular access point 124, the software application may automatically establish a cellular connection between the mobile device 108 and the cellular M2M chipset 104 by way of the cellular access point 124.

Once the cellular connection is established between the mobile device and the M2M chipset, the software application running on the mobile device 108 effectively operates as the HMI for the cellular M2M chipset 104, thereby enabling the user to remotely monitor, operate, and control the legacy device 130 by entering commands on the mobile device 108. It will be appreciated that the software application stored on the mobile device 108 coupled with the cellular access point 124 enables the user to establish a wireless cellular connection with the cellular M2M chipset 104, and thereby remotely operate the legacy device 130 without any prior specialized technical training being required on the part of the user.

It will be appreciated by those skilled in the art that although the client Wi-Fi interface 112 and the client cellular interface 120 are configured to connect to the communications network 116, the cellular access point 124 enables the mobile device 108 to connect directly to the cellular M2M chipset without first establishing a network connection by way of the communications network 116 and then being routed to the client Wi-Fi interface 112. Thus, legacy device 130 may be operated by way of the mobile device 108 over a direct cellular connection.

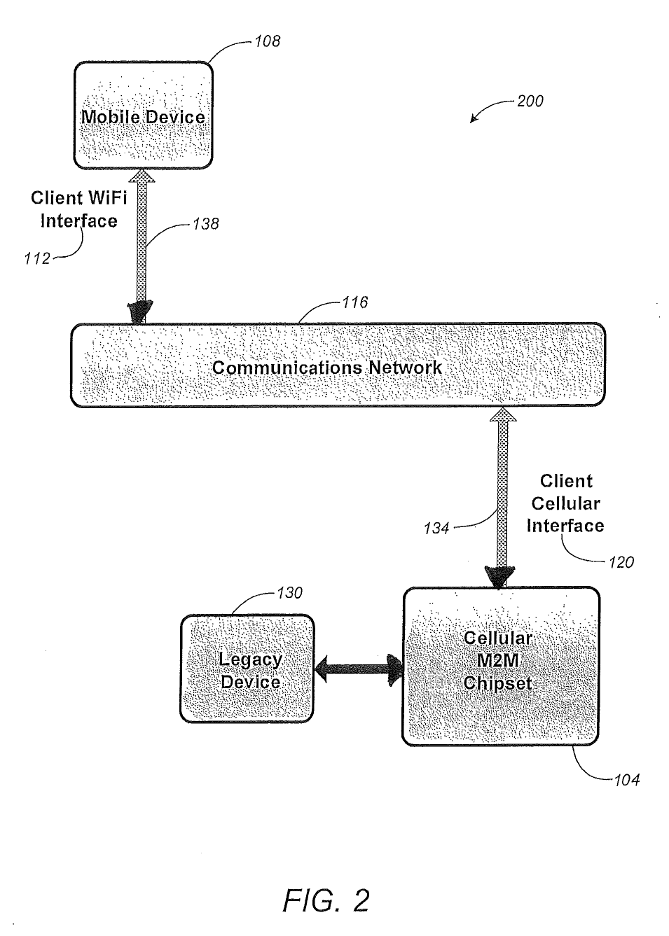

There may be instances, however, wherein network connectivity may be advantageous, such as when the mobile device 108 lacks direct cellular capability but comprises direct Wi-Fi connectivity. FIG. 2 illustrates an embodiment of an exemplary use environment 200 wherein the cellular M2M chipset 104, and thus the legacy device 130, is remotely operated or monitored by the mobile device 108 by way of a client cellular connection 134 and a network connection 138. Remotely monitoring and/or operating the legacy device 130 by way of the connections 134, 138 is substantially similar to operating and monitoring the legacy device 130 by way of the cellular access point 124 (FIG. 1), with the exception that the mobile device 108 must be first authenticated and deployed on the communications network 116 and data must be routed to the mobile device 108.

Once the network connections 134, 138 are established and the mobile device 108 and the cellular M2M chipset 104 are communicating over the network, the software application on the mobile device 108 enables the user to remotely operate and monitor the legacy device 130 by entering commands on the mobile device 108. Thus, the software application on the mobile device 108 operates as the HMI for the cellular M2M chipset 104, just as described above in connection with FIG. 1. It will be appreciated that the software application stored on the mobile device 108 that configures the processor of the mobile device for communication over connections 134, 138, coupled with the connections 134, 138, enables the user to connect with the cellular M2M chipset 104, and thereby remotely monitor and/or operate the legacy device 130 without any prior specialized technical training being required on the part of the user.

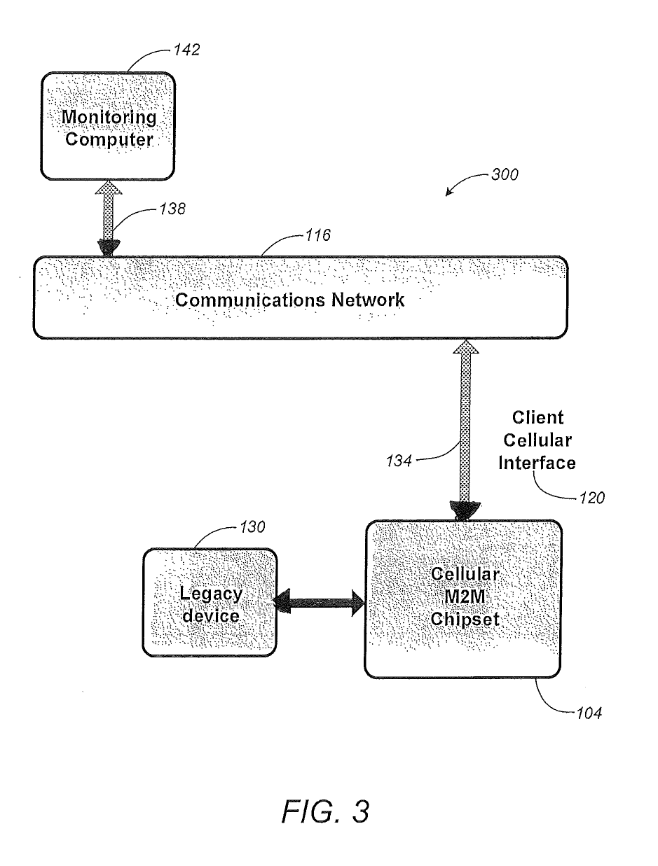

It will be appreciated by those skilled in the art that the mobile device 108 need not be limited to mobile devices, but rather other types of machines may be used to remotely operate the legacy device 130 in accordance with the present invention. FIG. 3 illustrates an embodiment of an exemplary use environment 300 wherein cellular M2M chipset 104 and legacy device 130 are remotely monitored and/or operated by way of a monitoring computer 142 by way of the connections 134, 138.

In an embodiment, the monitoring computer 142 may be a mobile phone or a tablet computer, as described above with reference to FIG. 1. In other embodiments, the monitoring computer 142 may be any portable computing device capable of participating in a wireless connection. In still other embodiments, the monitoring computer 142 may be non-portable computing equipment with network connectivity, such as, by way of example, computers used in factories, manufacturing, automated assembly lines, and the like. Similarly, it is envisioned that the legacy device 130 may be comprised of equipment used in manufacturing and assembly environments, or any other similar environment wherein legacy devices are used.

In an exemplary embodiment, the cellular M2M chipset 104 may periodically send information about the status of the legacy device 130, or other useful information, to the monitoring computer 142. In an exemplary embodiment, the monitoring computer 142 comprises a software application, substantially similar to the software application described in connection with FIGS. 1-2, wherein the software application configures a processor of the monitoring computer to receive information sent by the cellular M2M chipset 104 through client cellular interface 120, connection 134, communications network 116 and connection 138 then display the information to a user.

In another embodiment, the information transmitted by the cellular M2M chipset 104 may be deployed as a Webpage on the network, which periodically updates and displays new information received from the cellular M2M chipset 104. In still another embodiment, the monitoring computer 142 may be configured to receive M2M communications from the cellular M2M chipset 104 and then respond accordingly in absence of a human user. It will be appreciated by those skilled in the art that the client cellular connection 134 may be coupled with a wide variety of different monitoring computers 142 without deviating from the spirit and scope of the present invention. Such a response may include displaying the information to a user, providing a notification to a user, or providing control signals to the cellular M2M chipset that are then used to control legacy device 130.

It will be recognized by those skilled in the art that connecting machines over a cellular network tends to be very expensive due to the cost of conventional cellular chipsets. Conventional cellular chipsets have a relatively large throughput so as to support all the features and functions typical of modern cellular handsets. The cellular M2M chipset disclosed herein advantageously comprises specialized chips that have sufficient processing power to connect to an LTE network. Thus, the cellular M2M chipset of the various embodiments of the present invention preferably has a very low throughput compared to conventional cellular chipsets utilized in cellular handsets.

In one embodiment, the cellular M2M chipset is an LTE end-node chipset that will connect to an LTE network, but only has the functionally to provide M2M connectivity and operate as an active node. Thus, as will be recognized by those skilled in the art, the low throughput cellular M2M chipset disclosed herein is a much lower cost solution than conventional cellular chipsets.

In one embodiment, the software used to facilitate the algorithms discussed herein can be embodied onto a non-transitory machine-readable medium. A machine-readable medium includes any mechanism that stores information in a form readable by a machine, such as, for example, a computer.

While some specific embodiments of the present invention have been shown the invention is not to be limited to these embodiments. For example, most functions performed by electronic hardware components may be duplicated by software emulation. Thus, a software program written to accomplish those same functions may emulate the functionality of the hardware components in input-output circuitry. The present invention is to be understood as not limited by the specific embodiments described herein, but only by scope of the appended claims.

We claim:

1. A cellular M2M chipset for providing communication with and control a device having no network connectivity, comprising:
a processor;
a memory in operable communication with the processor;
a communication module in operative communications with the processor and the memory, the communication module providing for connection to a cellular network and a device or sensor having no ability to connect with a network; and
a software program stored in the memory, the software program consisting of programming commands for controlling the processor to establish a cellular connection through the communication module with a cellular network.

2. The chipset of claim 1, wherein the software program includes programming commands for controlling the processor to communicate with the device or sensor.

3. The chipset of claim 1, wherein the processor and communication module comprise a very low throughput compared to conventional cellular chipsets utilized in cellular handsets.

4. The chipset of claim 1, wherein the communication module is configured as an LTE end-node.

5. The chipset of claim 1, wherein the software program lacks programming commands for providing a user interface.

6. The chipset of claim 1, wherein the memory is a subscriber identification module.

7. A system for monitoring and/or controlling a device or sensor utilizing a cellular network, comprising:
a chipset having a processor, memory, and a communication module for establishing a connection with a cellular network and for establishing a connection with a device or sensor, the communication module including a cellular access point;
a subscriber identification card which is provisioned for establishing a connection to the cellular network; and
a client cellular interface supported by the cellular network connection, the client cellular interface being configured to establish communication with the cellular network, whereby data passed to the client cellular interface is routed within the cellular network to a computing device.

8. The system of claim 7, wherein the chipset is an LTE end-node chipset.

9. The apparatus of claim 7, wherein the chipset comprises limited functionality so as to support M2M connectivity.

10. The system of claim 7, wherein the chipset lacks a user interface or a Human Machine Interface (HMI).

11. The system of claim 7, wherein the device or sensor is incapable of communicating or establishing network connections in absence of the chipset.

12. The system of claim 7, wherein the computing device is configured to receive M2M communications from the chipset.

13. The system of claim 7, further comprising a software application stored on a non-transitory machine-readable medium of the computing device, wherein the software application is configured to establish a cellular connection between the computing device and the chipset by way of the cellular access point, and wherein the software application effectively operates as a user interface for the chipset, thereby enabling a user to remotely monitor, operate, and control the device or sensor by way of the computing device.

14. The system of claim 7, wherein the computing device is a mobile phone or a tablet computer.

15. The system of claim 7, wherein the computing device is a portable computing device capable of participating in a wireless cellular connection.

16. The system of claim 7, wherein the chipset periodically sends information about the status of the device or sensor to the computing device.

17. The system of claim 16, wherein the computing device includes a software application which receives the information sent by the chipset and then displays the information to a user.

18. The apparatus of claim 16, wherein the information is deployed as a Webpage, which periodically updates and displays new information received from the chipset.

19. A method for connecting a computing device to a legacy device so as to remotely monitor, operate, or control the legacy device, the method comprising:
providing a cellular machine-to-machine (M2M) chipset that is capable of establishing a cellular network connection in cooperation with a Subscriber Identification Module (SIM) which is provisioned with a cellular network connection;
configuring the cellular network connection to support a client cellular interface and a cellular access point, wherein the client cellular interface is configured to establish cellular connections with a communications network, whereby data passed to the client cellular interface is routed within the communications network to the computing device, and wherein the cellular access point is configured to receive cellular connections whereby the computing device may connect directly to the cellular M2M chipset; and
coupling the cellular M2M chipset to the legacy device, such that the legacy device is responsive to commands received from the computer device to the cellular M2M chipset by way of the cellular network connection.

20. The method of claim 19, further comprising providing a software application stored on a non-transitory machine-readable medium of the computing device, wherein the software application is configured to establish a cellular connection between the computing device and the cellular M2M chipset by way of the cellular network connection, and wherein the software application effectively operates as a user interface for the cellular M2M chipset, thereby enabling a user to remotely monitor, operate, or control the legacy device by way of the computing device.

21. The method of claim 19, wherein coupling the cellular M2M chipset to the legacy device further comprises configuring the cellular M2M chipset to periodically send information about the status of the legacy device to the computing device.

22. The method of claim 19, wherein the computing device includes a software application which receives the information sent by the cellular M2M chipset and then displays the information to the user, and wherein the software application sends user-entered commands to the cellular M2M chipset, such that the software application operates as a Human Machine Interface (HMI) for the cellular M2M chipset.
